(19) United States
(12) Patent Application Publication
(10) Pub. No.: US 2015/0094627 A1
(43) Pub. Date: Apr. 2, 2015

(54) Massager with Symmetric Massaging Structure

(71) Applicant: Jue-Yao Chen, Erlin Township (TW)

(72) Inventor: Jue-Yao Chen, Erlin Township (TW)

(21) Appl. No.: 14/040,774

(22) Filed: Sep. 30, 2013

(51) Int. Cl. A61H 1/00

(52) U.S. Cl. CPC A61H 1/008
USPC 601/134

(57) ABSTRACT

A massager with symmetric massaging structure includes first and second casing assemblies coupled to a connection belt each and connected pivotally by first and second movable sleeves, respectively. The casing assemblies, whose included angles are adjustable, have therein power sources for driving first and second transmission members connecting with and driving first and second massaging sets to knead a user's body in a fixed-point manner. The transmission members drive the tooth-guiding groove screws to advance toward the movable sleeves in a fixed-point manner, respectively. With first and second tooth-like keys, the movable sleeves engage with tooth-guiding grooves of the tooth-guiding groove screws, respectively. The tooth-guiding groove screws rotate to pull synchronously the casing assemblies toward each other or away from each other. After restoring its initial position, one said massaging set does not move together with the other massaging set until the other massaging set restores its initial position too.

### BACKGROUND OF THE INVENTION

1. Technical Field

The present invention relates to massagers, and more particularly, to a massager with symmetric massaging structure, characterized in that: first and second massaging sets can operate in different modes, that is, the first and second massaging sets either knead a user's body in a fixed-point manner or move laterally by moving synchronously toward each other or away from each other to thereby knead the user's body; wherein, after restoring its initial position, the first massaging set does not start to move together with the second massaging set until the second massaging set restores its initial position too, and, conversely, after restoring its initial position, the second massaging set does not start to move together with the first massaging set until the first massaging set restores its initial position too; and each round trip is accompanied by an instance of adjustment of electromechanical speed, such that the first and second massaging sets move synchronously.

2. Description of Related Art

People nowadays work very hard and thus seldom perceive soreness in the lower back, shoulders, and/or legs until they get off from work. The soreness triggers a desire to not only receive a soothing massage but also go home for rest as soon as possible. The best way to satisfy the two aforesaid needs simultaneously is to purchase a massage device for use at home, so as to receive a soothing massage at home in a relaxing manner. To this end, a wide variety of conventional massage devices are commercially available.

Conventional massagers are mostly massage chairs. However, massage chairs have their disadvantages as follows: too bulky to be storable indoors and movable freely to massage all parts of a user's body; and too pricy to be affordable. Furthermore, the conventional massagers fail to stay away from the spinal column and thus are ineffective in massaging synchronously the lumbar muscles which flank the spinal column Accordingly, there is still room for improvement of the conventional massagers.

### SUMMARY OF THE INVENTION

It is an objective of the present invention to provide a massager with symmetric massaging structure, characterized in that: first and second massaging sets can operate in different modes, that is, the first and second massaging sets either knead the user's body in a fixed-point manner, or move laterally by moving synchronously toward each other or away from each other to thereby knead the user's body; after restoring its initial position, the first massaging set does not start to move together with the second massaging set until the second massaging set restores its initial position too, and, conversely, after restoring its initial position, the second massaging set does not start to move together with the first massaging set until the first massaging set restores its initial position too; and each round trip is accompanied by an instance of adjustment of electromechanical speed, such that the first and second massaging sets move synchronously.

In order to achieve the above and other objectives, the present invention provides a massager with symmetric massaging structure, comprising: first and second casing assemblies coupled to and flanked by the connection belts, respectively; first and second handles connected to free ends of the two connection belts, respectively; first and second movable sleeves, wherein the first and second casing assemblies are connected pivotally by the first and second movable sleeves, respectively, such that specific included angles between the first and second casing assemblies are adjustable so as for the first and second casing assemblies to be bent relative to each other; first and second power sources disposed in the first and second casing assemblies to drive the first and second transmission members to move, respectively; first and second massaging sets, wherein the first and second transmission members protrude from the first and second casing assemblies to connect with and drive the first and second massaging sets to move, respectively; first and second tooth-guiding groove screws, wherein the first and second transmission members drive the first and second tooth-guiding groove screws to advance in a direction of the first and second movable sleeves in a fixed-point manner, respectively; wherein first and second tooth-like keys enable the first and second movable sleeves to be engaged with circumferential tooth-guiding grooves of the first and second tooth-guiding groove screws, respectively; wherein the first and second tooth-guiding groove screws rotate to pull synchronously the first and second casing assemblies toward each other or away from each other, such that the first and second massaging sets knead the user's body in a fixed-point manner; wherein the user presses a reverse button to allow the first and second massaging sets to move toward each other and knead the user's body; wherein, after restoring its initial position, the first massaging set does not start to move together with the second massaging set but is idle until the second massaging set restores its initial position too, and, conversely, after restoring its initial position, the second massaging set does not start to move together with the first massaging set but is idle until the first massaging set restores its initial position too; wherein each round trip is accompanied by an instance of adjustment of electromechanical speed, until the first and second massaging sets move synchronously.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic perspective view of a massager with symmetric massaging structure according to an embodiment of the present invention;

FIG. 2 is an exploded view of the massager with symmetric massaging structure according to the embodiment of the present invention;

FIG. 3 is an exploded view of first and second transmission members of the massager with symmetric massaging structure according to the embodiment of the present invention;

FIG. 4 is an exploded view of a first movable sleeve of the massager with symmetric massaging structure according to the embodiment of the present invention;

FIG. 5 is a schematic perspective view of the first movable sleeve according to the embodiment of the present invention;

FIG. 6 is an exploded view of a second movable sleeve of the massager with symmetric massaging structure according to the embodiment of the present invention;

FIG. 7 is an exploded view of an electrical control panel of the massager with symmetric massaging structure according to the embodiment of the present invention;

FIG. 8 is a schematic view of synchronous operation of first and second massaging sets of the massager with symmetric massaging structure according to the embodiment of the present invention;

FIG. 9 is a schematic view of adjustment of specific included angles of first and second casing assemblies of the massager with symmetric massaging structure according to the embodiment of the present invention;

FIG. 10 is a schematic view of lower back massage performed with the massager with symmetric massaging structure according to the embodiment of the present invention;

FIG. 11 is a schematic view of shoulder massage performed with the massager with symmetric massaging structure according to the embodiment of the present invention; and

FIG. 12 is a schematic view of leg massage performed with the massager with symmetric massaging structure according to the embodiment of the present invention.

### DETAILED DESCRIPTION OF THE EMBODIMENT OF THE INVENTION

The present invention provides a massager with symmetric massaging structure.

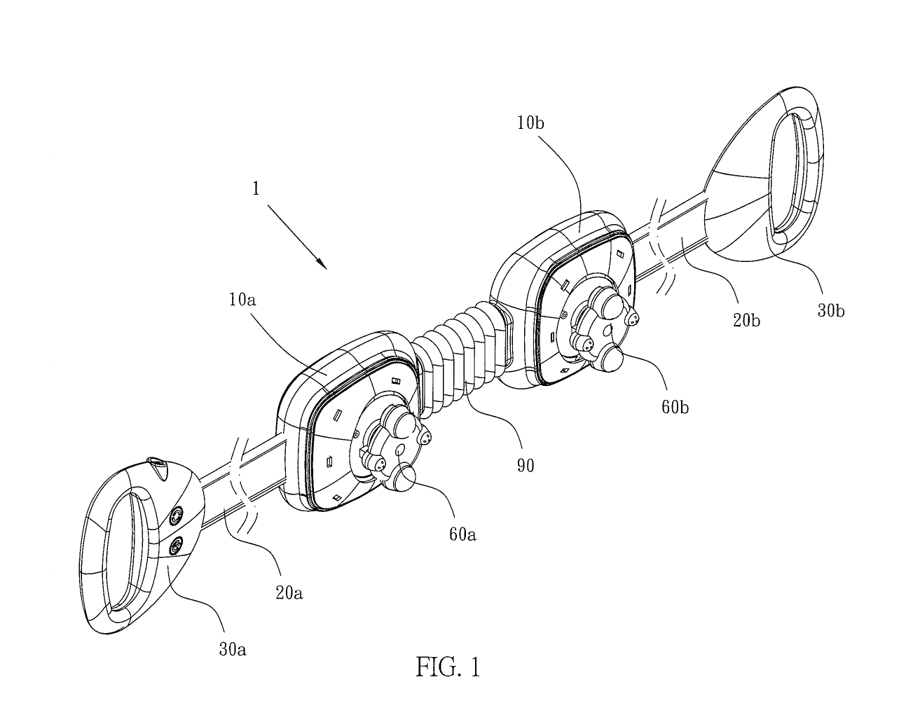

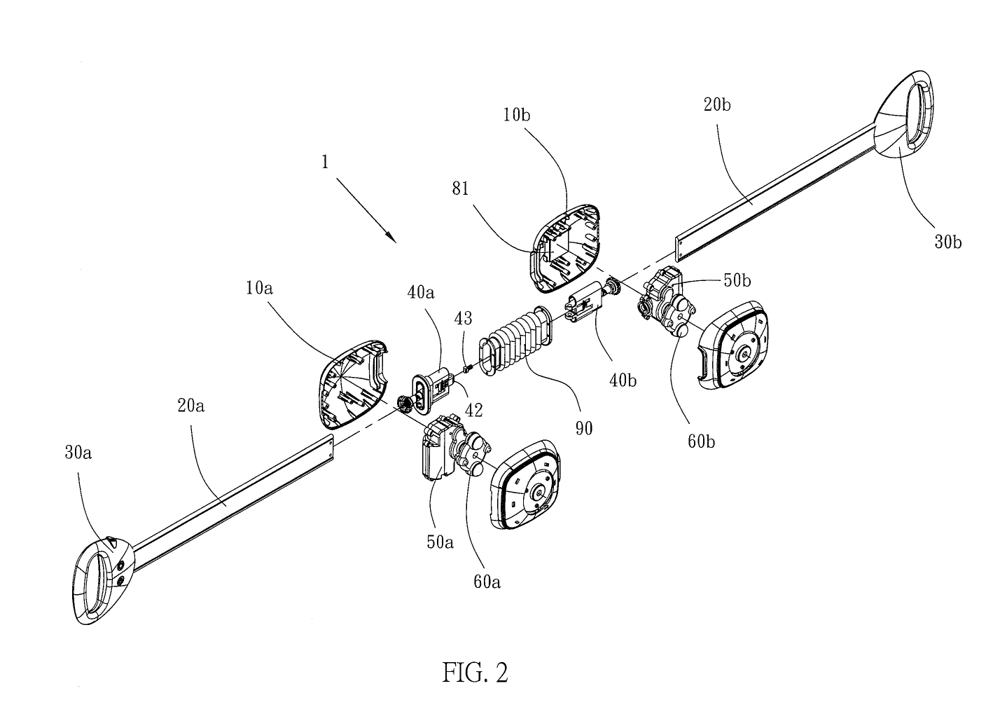

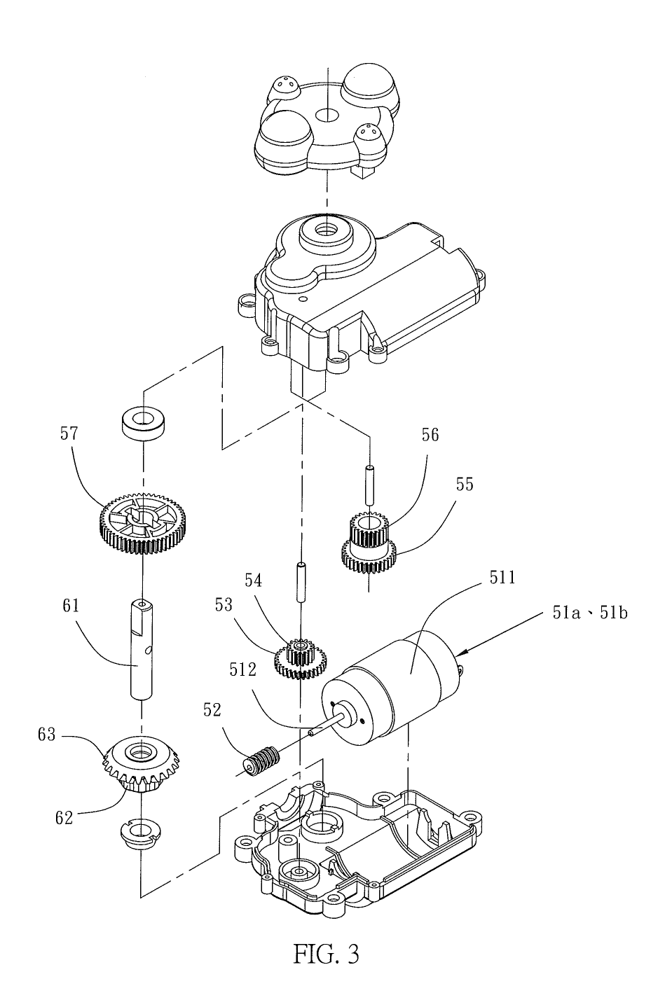

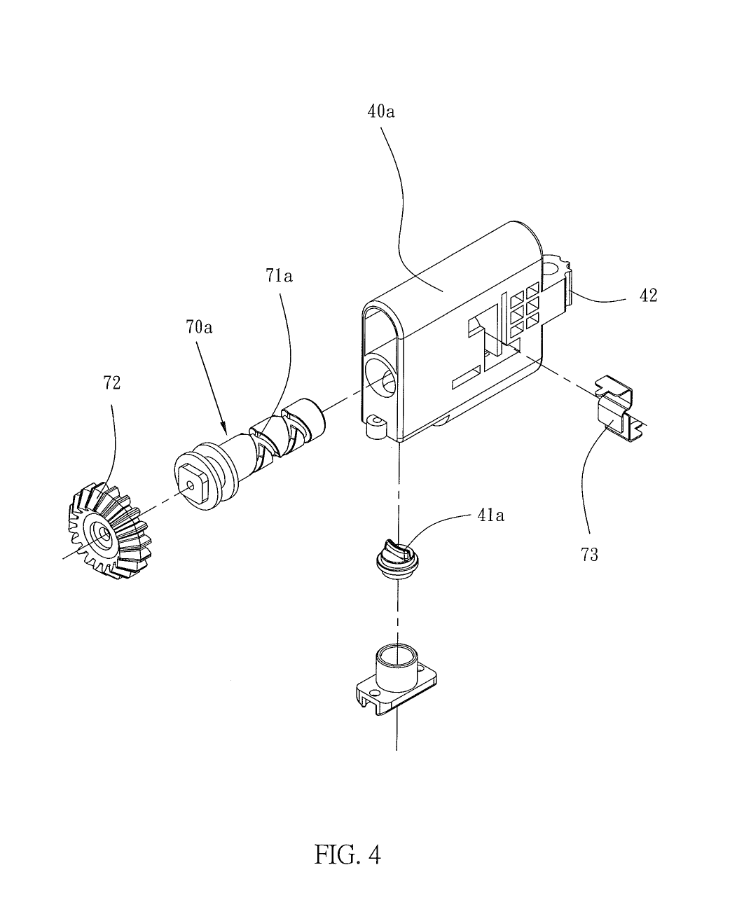

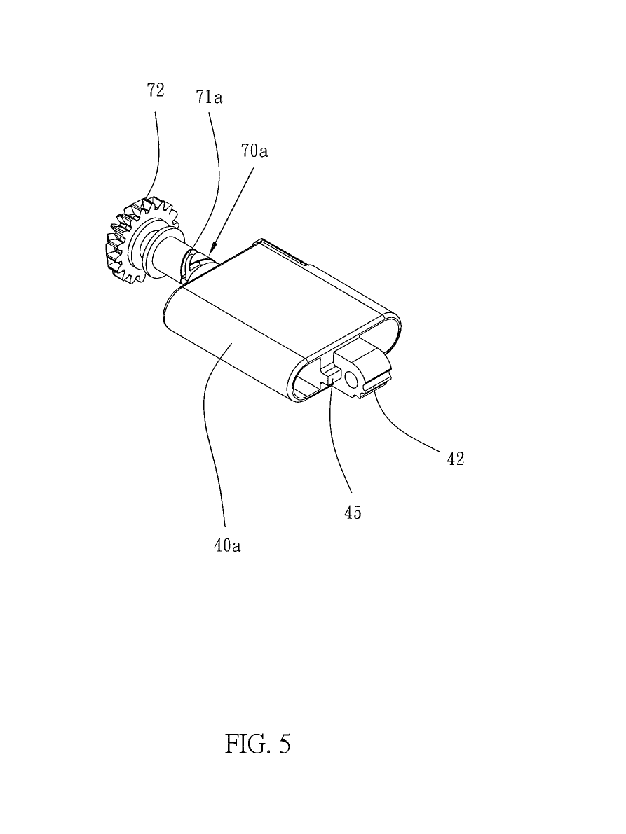

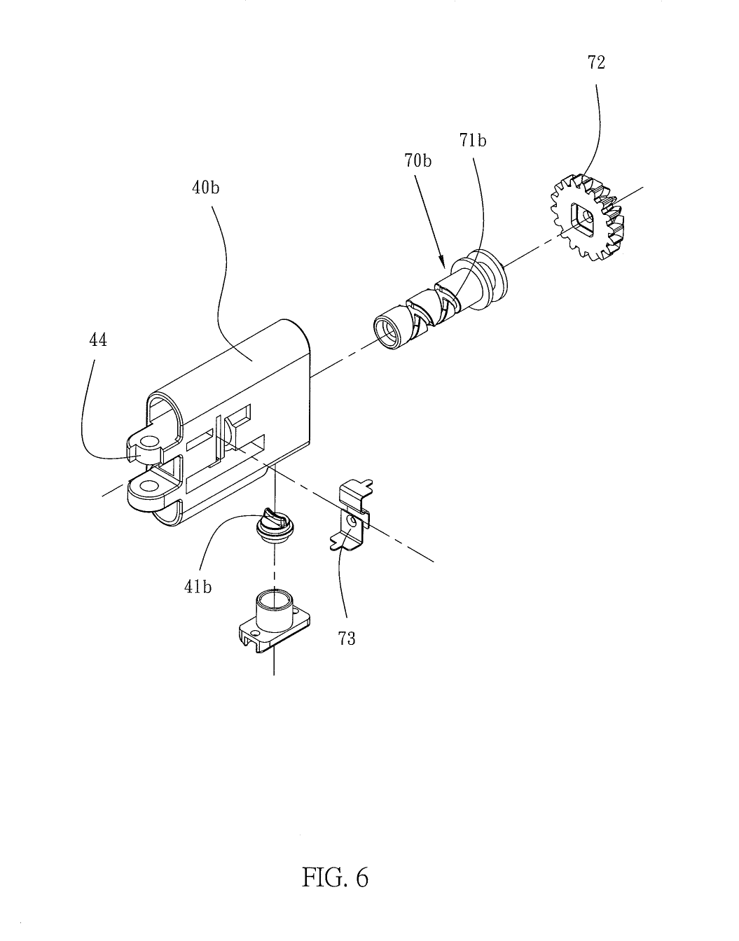

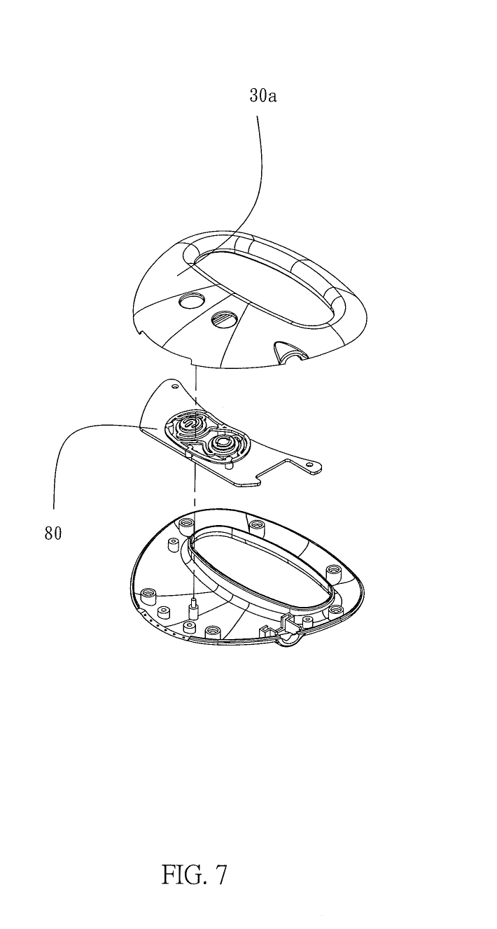

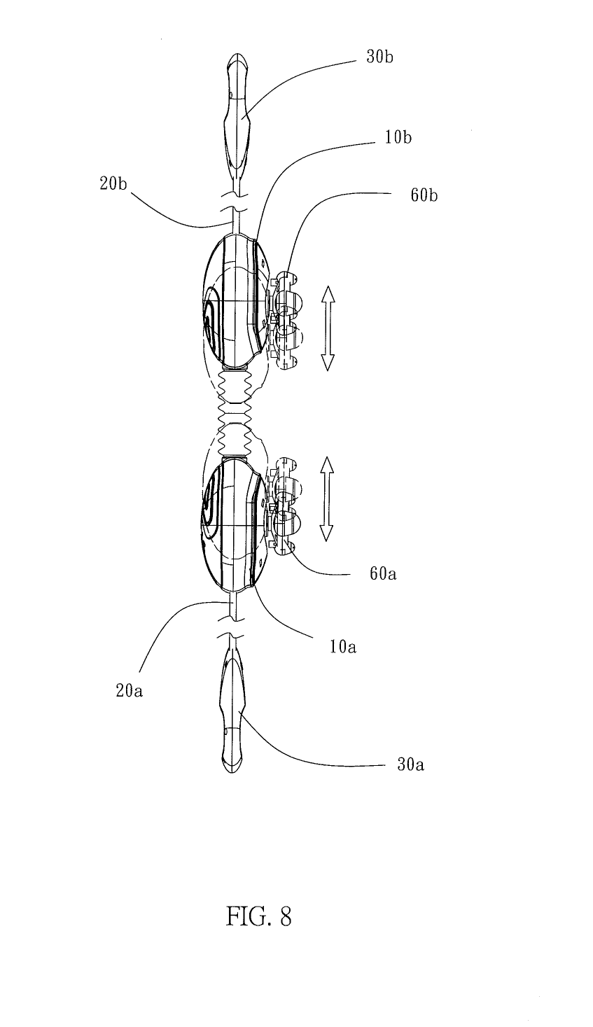

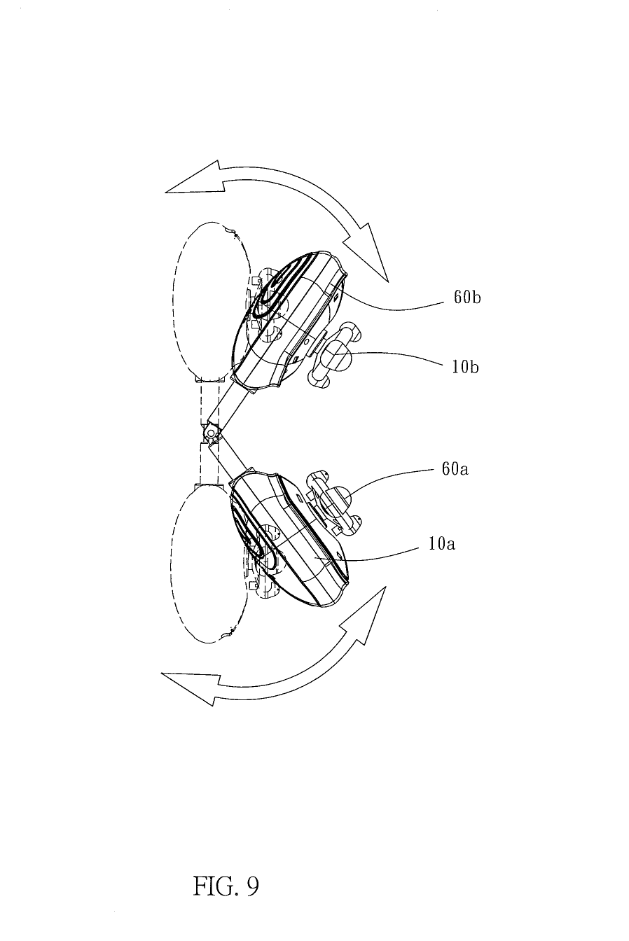

Referring to FIG. 1 through FIG. 9, a massager 1 with symmetric massaging structure of the present invention comprises first and second casing assemblies 10a, 10b, two connection belts 20a, 20b, first and second movable sleeves 40a, 40b, first and second transmission members 50a, 50b, first and second massaging sets 60a, 60b, and first and second tooth-guiding groove screws 70a, 70b.

The first and second casing assemblies 10a, 10b are coupled to and flanked by the connection belts 20a, 20b, respectively.

The first and second casing assemblies 10a, 10b are connected pivotally by the first and second movable sleeves 40a, 40b, respectively, such that specific included angles between the first and second casing assemblies 10a, 10b are adjustable so as for a user to bend the first and second casing assemblies 10a, 10b relative to each other at a point of pivotal connection.

The first and second casing assemblies 10a, 10b have therein first and second power sources 51a, 51b for driving the first and second transmission members 50a, 50b to move, respectively.

The first and second transmission members 50a, 50b are connected to the first and second massaging sets 60a, 60b positioned outside the first and second casing assemblies 10a, 10b, respectively, such that the first and second transmission members 50a, 50b drive the first and second massaging sets 60a, 60b to move, respectively.

The first and second transmission members 50a, 50b drive the first and second tooth-guiding groove screws 70a, 70b to advance in the direction of the first and second movable sleeves 40a, 40b in a fixed-point manner, respectively. First and second tooth-like keys 41a, 41b enable the first and second movable sleeves 40a, 40b to be engaged with circumferential tooth-guiding grooves 71a, 71b of the first and second tooth-guiding groove screws 70a, 70b, respectively; hence, the first and second tooth-guiding groove screws 70a, 70b rotate to pull synchronously the first and second casing assemblies 10a, 10b toward each other or away from each other. Hence, the first and second massaging sets 60a, 60b knead the user's body in a fixed-point manner and in an electrically controlled manner. Alternatively, the first and second massaging sets 60a, 60b are electrically controlled to move laterally by moving synchronously toward each other or away from each other to thereby knead the user's body. After restoring its initial position, the first massaging set 60a does not start to move together with the second massaging set 60b but stays idle until the second massaging set 60b restores its initial position too; conversely, after restoring its initial position, the second massaging set 60b does not start to move together with the first massaging set 60a but stays idle until the first massaging set 60a restores its initial position too. Each round trip is accompanied by an instance of adjustment of electromechanical speed of the first and second power sources 51a, 51b, until the first and second massaging sets 60a, 60b move synchronously.

As regards the massager 1 with symmetric massaging structure, first and second handles 30a, 30b are connected to the free ends of the two connection belts 20a, 20b, respectively.

As regards the massager 1 with symmetric massaging structure, a hook-and-loop fastener structure is disposed at the free end of each of the two connection belts 20a, 20b.

As regards the massager 1 with symmetric massaging structure, the first and second power sources 51a, 51b are a motor 511 each. The motor 511 has a spindle 512.

As regards the massager 1 with symmetric massaging structure, the first and second transmission members 50a, 50b each comprise a worm gear 52 fixed to the spindle 512 of the motor 511. The worm gear 52 meshes with a first gear 53. The first gear 53 is fixed to a second gear 54. The second gear 54 meshes with a third gear 55. The third gear 55 is fixed to a fourth gear 56. The fourth gear 56 meshes with a fifth gear 57. The first and second massaging sets 60a, 60b have an axle 61 each. The axle 61 penetrates the fifth gear 57 and is fixed thereto. The axle 61 is fixed pivotally to a one-way bearing 62. The one-way bearing 62 is engaged circumferentially with a first bevel gear 63. The first and second tooth-guiding groove screws 70a, 70b are fixed to a second bevel gear 72 each. The first bevel gear 63 meshes with the second bevel gear 72.

The massager 1 with symmetric massaging structure further comprises an electrical control panel 80. The electrical control panel 80 is electrically connected to a battery 81 or a grid power outlet. The electrical control panel 80 is electrically connected to two said motors 511 to take control over two said motors 511. A plurality of leaf springs 73 spaced apart from each other is disposed in the first and second movable sleeves 40a, 40b, corresponds in position to the positions of limit of movement of the first and second tooth-guiding groove screws 70a, 70b, and, when pressed, comes into contact therewith so as to generate a restoration completion signal. The electrical control panel 80 is electrically connected to the plurality of leaf springs 73 to receive therefrom the control signal, such that the first and second massaging sets 60a, 60b move synchronously.

As regards the massager 1 with symmetric massaging structure, the first movable sleeve 40a has notches 42 corresponding in position to a point of pivotal connection of the first and second movable sleeves 40a, 40b and arranged according to a specific angle, whereas the second movable sleeve 40b has a spring support post 43 corresponding in position to the point of pivotal connection of the first and second movable sleeves 40a, 40b and adapted to be engaged with and positioned at one of the notches 42 when aligned therewith.

As regards the massager 1 with symmetric massaging structure, the first movable sleeve 40a has a position-limiting bump 45 corresponding in position to the point of pivotal connection of the first and second movable sleeves 40a, 40b, whereas the second movable sleeve 40b has a curved position-limiting groove 44 corresponding in position to the point of pivotal connection of the first and second movable sleeves 40a, 40b and adapted to receive the position-limiting bump 45, so as to restrict the angular range of motion of the first and second movable sleeves 40a, 40b.

As regards the massager 1 with symmetric massaging structure, a retractable tube soft plastic sheath 90 covers the first and second movable sleeves 40a, 40b and exists between the first and second casing assemblies 10a, 10b.

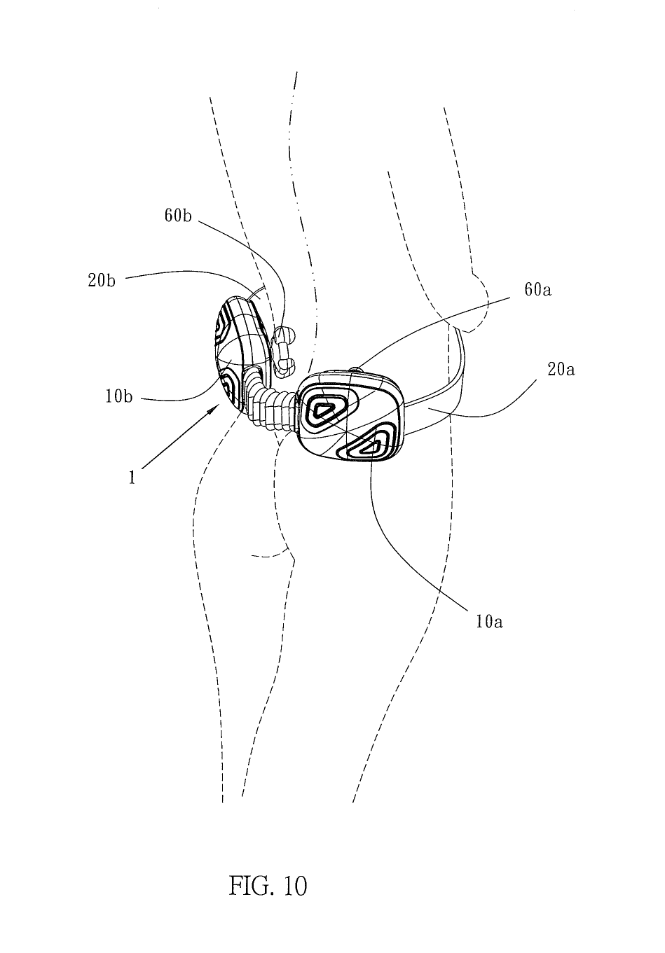

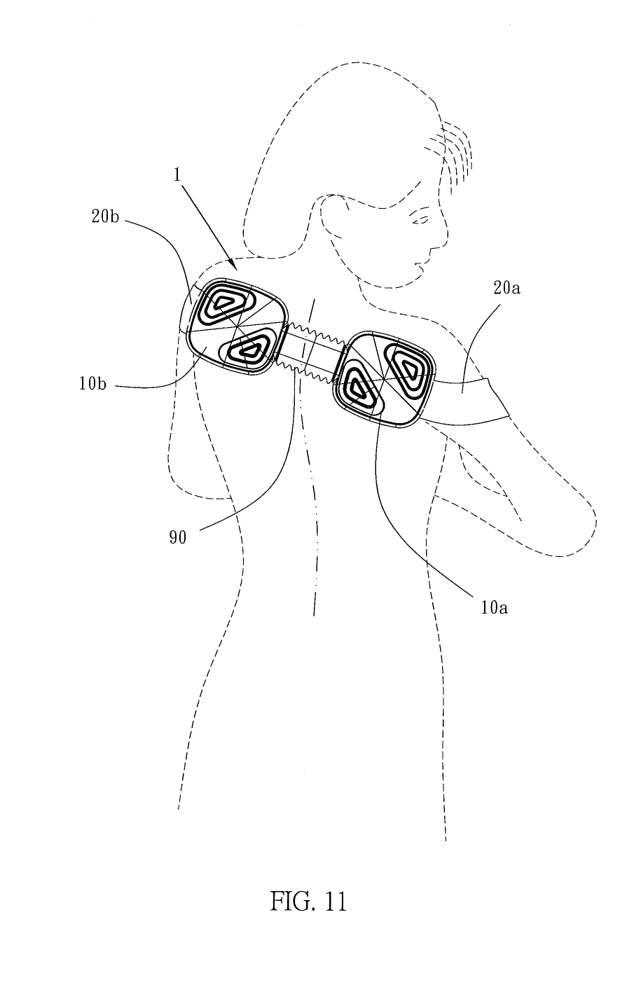

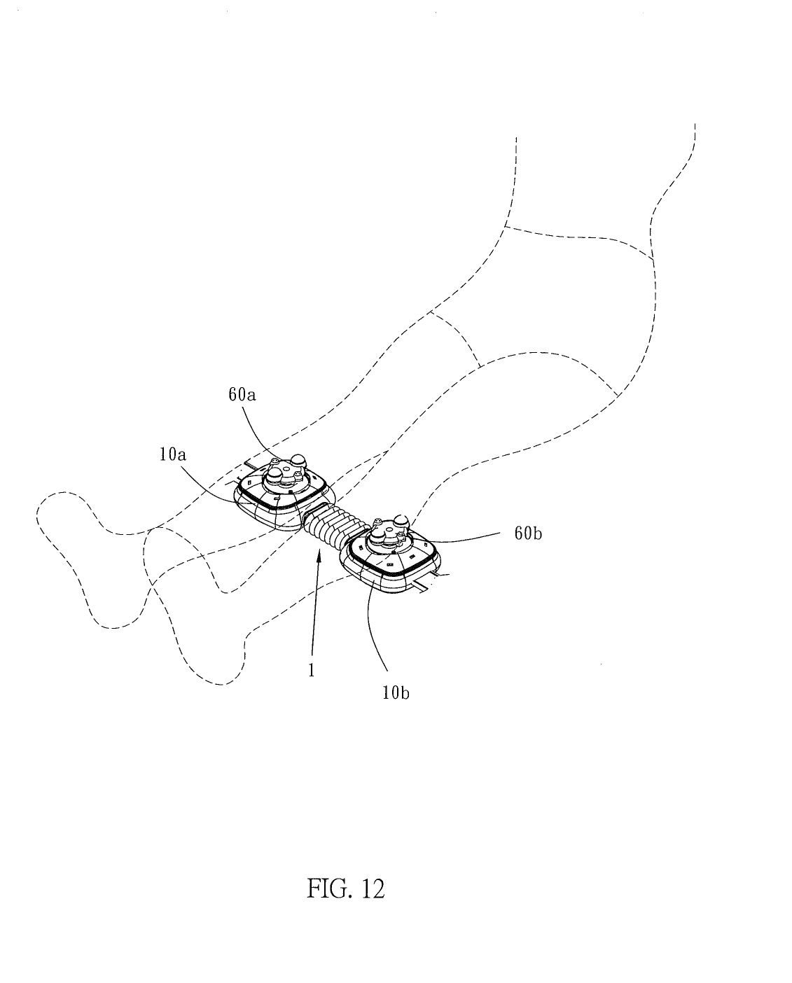

Referring to FIG. 10 through FIG. 12, the massager 1 of the present invention performs massage bilaterally and stays away from the spinal column. As the width of the spinal column varies from person to person, the massager 1 of the present invention adjusts the included angles between the first and second casing assemblies 10a, 10b within the range of 35° to 70°, such that the massager 1 of the present invention is suitable for use with different persons and different massage positions. Furthermore, due to the aforesaid included angle adjustment, the massager 1 of the present invention can perform massage on the user's different acupuncture points. Furthermore, with its orientation being adjustable, the massager 1 of the present invention can perform massage on the user's waist (shown in FIG. 10), the user's back and shoulders (shown in FIG. 11), and the user's legs (shown in FIG. 12). The first and second massaging sets 60a, 60b can either perform massage in a fixed-point manner or move laterally and synchronously while performing massage.

Referring to FIG. 1 through FIG. 12, the first and second massaging sets 60a, 60b begin to knead the user's body in a fixed-point manner as soon as the user presses a power button of the electrical control panel 80, and the first and second massaging sets 60a, 60b stop performing massage as soon as the user presses the power button again.

It is only after the user has pressed and started the power button that the user can press a reverse button of the electrical control panel 80. As soon as the reverse button is pressed, the first and second massaging sets 60a, 60b knead reversely and restore their initial positions. After restoring its initial position, the first massaging set 60a does not start to move together with the second massaging set 60b but stays idle until the second massaging set 60b restores its initial position too; conversely, after restoring its initial position, the second massaging set 60b does not start to move together with the first massaging set 60a but stays idle until the first massaging set 60a restores its initial position too. That is to say, after both the first and second massaging sets 60a, 60b have restored their initial positions, the first and second massaging sets 60a, 60b begin to knead the user's body reversely and move laterally. Each round trip is accompanied by an instance of adjustment of electromechanical speed of the motors 511, until the first and second massaging sets 60a, 60b move synchronously. At this point in time, if the user presses the reverse button again, the first and second massaging sets 60a, 60b will begin to knead the user's body in a fixed-point manner. The aforesaid button-pressing instances can cycle.

Accordingly, the massager with symmetric massaging structure of the present invention is not only novel and thus meets the novelty requirement of an invention patent, but is also extensively innovative and thus meets the inventiveness requirement of an invention patent. Furthermore, the massager with symmetric massaging structure of the present invention manifests industrial applicability, as the massager with symmetric massaging structure of the present invention is advantageously characterized in that: the first and second massaging sets can operate in different modes, that is, the first and second massaging sets either knead the user's body in a fixed-point manner, or move laterally by moving synchronously toward each other or away from each other to thereby knead the user's body; after restoring its initial position, one said massaging set does not move together with the other massaging set until the other massaging set restores its initial position too, such that the first and second massaging sets move synchronously.

What is claimed is:

1. A massager with symmetric massaging structure, comprising:
first and second casing assemblies;
first and second movable sleeves, wherein the first and second casing assemblies are connected pivotally by the first and second movable sleeves, respectively, such that specific included angles between the first and second casing assemblies are adjustable so as for the first and second casing assemblies to be bent relative to each other at a point of pivotal connection;
first and second transmission members, wherein the first and second casing assemblies have therein first and second power sources for driving the first and second transmission members to move, respectively;
first and second massaging sets, wherein the first and second transmission members protrude from the first and second casing assemblies to connect with and drive the first and second massaging sets to move, respectively; and
first and second tooth-guiding groove screws, wherein the first and second transmission members drive the first and second tooth-guiding groove screws to advance in a direction of the first and second movable sleeves in a fixed-point manner, respectively, wherein first and second tooth-like keys enable the first and second movable sleeves to be engaged with circumferential tooth-guiding grooves of the first and second tooth-guiding groove screws, respectively, wherein the first and second massaging sets knead a user's body in a fixed-point manner whenever the first and second tooth-guiding groove screws are not rotating, wherein rotation of the first and second tooth-guiding groove screws drives the first and second casing assemblies and the first and second massaging sets to move laterally by moving synchronously toward each other or away from each other to thereby knead the user's body.

2. The massager with symmetric massaging structure of claim 1, wherein the first and second casing assemblies are coupled to and flanked by a connection belt each.

3. The massager with symmetric massaging structure of claim 2, wherein first and second handles are connected to free ends of the two connection belts, respectively.

4. The massager with symmetric massaging structure of claim 2, wherein a hook-and-loop fastener structure is disposed at a free end of each of the two connection belts.

5. The massager with symmetric massaging structure of claim 1, wherein the first and second power sources are each a motor having a spindle.

6. The massager with symmetric massaging structure of claim 5, wherein the first and second transmission members each comprise a worm gear fixed to the spindle of the motor, the worm gear meshing with a first gear, the first gear being fixed to a second gear, the second gear meshing with a third gear, the third gear being fixed to a fourth gear, the fourth gear meshing with a fifth gear, wherein the first and second massaging sets each have an axle penetrating the fifth gear and being fixed thereto, wherein the axle is fixed pivotally to a one-way bearing, the one-way bearing being engaged circumferentially with a first bevel gear, wherein the first and second tooth-guiding groove screws are each fixed to a second bevel gear meshing with the first bevel gear.

7. The massager with symmetric massaging structure of claim 5, further comprising an electrical control panel electrically connected to one of a battery and a grid power outlet and electrically connected to two said motors to take control over two said motors, wherein a plurality of leaf springs spaced apart from each other is disposed in the first and second movable sleeves, corresponds in position to positions of limit of movement of the first and second tooth-guiding groove screws, and, when pressed, comes into contact therewith to generate a control signal, wherein the electrical control panel is electrically connected to the plurality of leaf springs to receive the control signal.

8. The massager with symmetric massaging structure of claim 1, wherein the first movable sleeve has notches corresponding in position to a point of pivotal connection of the first and second movable sleeves and arranged according to a specific angle, and the second movable sleeve has a spring support post corresponding in position to the point of pivotal connection of the first and second movable sleeves and adapted to be engaged with and positioned at one of the notches when aligned therewith.

9. The massager with symmetric massaging structure of claim 1, wherein the first movable sleeve has a position-limiting bump corresponding in position to a point of pivotal connection of the first and second movable sleeves, and the second movable sleeve has a curved position-limiting groove corresponding in position to the point of pivotal connection of the first and second movable sleeves and adapted to receive the position-limiting bump.

10. The massager with symmetric massaging structure of claim 1, wherein a retractable tube soft plastic sheath covers the first and second movable sleeves and exists between the first and second casing assemblies.
